(19) United States
(12) Patent Application Publication
(10) Pub. No.: US 2016/0309308 A1
(43) Pub. Date: Oct. 20, 2016

(54) SYSTEM AND METHOD FOR SYNCHRONIZED TWO-WAY COMMUNICATIONS BETWEEN MOBILE DEVICES AND A WEBSITE PLATFORM

(71) Applicant: Atomic55 Internet Technologies Inc., Kelowna (CA)

(72) Inventor: Ryan GRUNDY, Kelowna (CA)

(21) Appl. No.: 15/006,624

(22) Filed: Jan. 26, 2016

Related U.S. Application Data
(60) Provisional application No. 62/148,787, filed on Apr. 17, 2015.

(51) Int. Cl. H04W 4/14; H04L 29/08

(52) U.S. Cl. CPC H04W 4/14; H04L 67/02

(57) ABSTRACT

The disclosure is directed at a method and system for two-way communication between a SMS-enabled device and a website platform using SMS technology. The system allows users who are visiting a website to communication with individuals associated with the webpage to ask questions relating to website content. The questions are delivered to an individual associated with the website using SMS technology which allows the individual to be contacted directly.

### CROSS-REFERENCE TO OTHER APPLICATIONS

This application claims the benefit of U.S. Provisional Patent Application No. 62/148,787, filed Apr. 17, 2015, the contents of which are hereby incorporated by reference.

### FIELD

The disclosure is generally directed at online communication tools and more specifically at a system and method for synchronized two-way communications between a mobile device and a website platform using short message service (SMS) technology.

### BACKGROUND

In the online world, users typically access websites to engage with the content of those websites to read the information that is provided. In some situations, the users may have questions regarding the content and wish to contact someone associated with the website to ask these questions. There are currently numerous solutions which allow a user to interact with a website to communicate with individuals associated with the website.

For instance, in some websites, users are able to open a chat window between the user and the website individual. However, this solution requires a user to be stationary and remain in front of the desktop computer for the entirety of the conversation. In many cases, these chat windows require software to be installed on a user's computer as well.

Alternatively, users may be provided with the option to send an email to the individuals associated with the website in order to start an email conversation. However, this form of communication may not be as instantaneous as a conversation and result in the user needing to wait for a period of time before receiving a response to their questions.

Therefore, there is provided a novel system and method for synchronized two-way communications between a mobile device and a website platform.

### SUMMARY

The current disclosure is directed at a system and method embedded in a website for the purpose of providing a chat tool for visitors (seen as users) to the website to communicate, via short message service (SMS) technology, with individuals associated with the website such as, but not limited to, the website's owner or someone associated to or designated by the website owner. In one embodiment, where the website is related to real estate transactions, the system and method may be used to allow visitors to the website to contact or communicate with remote sales agents.

An advantage of the current disclosure is that the system and method of the disclosure is embedded within the website such that there is no software installed on the device that the visitor is using to access the website, such as, but not limited to, a computer, a laptop, a smartphone or the like. The message or question from the visitor is then sent directly to a website owner's SMS-enabled mobile device, such as a cellular telephone, tablet or watch, via SMS technology. The website owner is then able to respond via SMS and that message is sent back to the visitor who can view the message in the chat tool. A conversation may then be started between the visitor and the website owner.

Advantages of the system include that the website owner also does not have to install an application on their mobile device to communicate with the visitor, the website owner is able to directly communicate with visitors to the website without having to launch a separate application, such as a web based chat window and the website owner does not need to be logged into a system in order to provide a response.

### DESCRIPTION OF FIGURES

Embodiments of the present disclosure will now be described, by way of example only, with reference to the attached Figures.

FIG. 1 is a flowchart of a first embodiment of how a chat tool is implemented;

FIG. 2 is a schematic diagram of a method and system for implementing and use of a chat tool;

FIG. 3a is an example screenshot of one embodiment of what a website owner sees when initial chat data is transmitted;

FIG. 3b is an example screenshot of an email notification which may be sent to a website owner;

FIG. 3c is an example screenshot of a message to the website owner indicating another individual has responded to the initial chat data;

FIG. 3d is another example screenshot of what a website owner may see when initial chat data is transmitted;

FIG. 3e is an example screenshot of what a website owner may see if a website owner is unable to respond to the initial chat data;

FIG. 3f is an example screenshot of what a website owner or responder may see when a conversation is closed by the visitor;

FIG. 3g is an example screenshot of what a visitor may see if a website owner is unable to respond to the initial chat data;

FIG. 4a is an example screenshot of a website including a chat tool;

FIG. 4b is an example screenshot of a chat tool entry box;

FIG. 5a is a schematic diagram of apparatus for two-way communication;

FIG. 5b is a schematic diagram of a system for two-way communication for use within the apparatus for two-way communication of FIG. 5a;

FIG. 6a is a flowchart outlining a method of user interaction with the system according to one embodiment;

FIG. 6b is a flowchart outlining a method of providing two-way communications using SMS technology according to one embodiment;

FIG. 6c is a flowchart outlining a method or website owner interaction with the system according to one embodiment;

FIGS. 7a and 7b are screenshots of the system integrated within a real estate website;

FIGS. 8a and 8b are screenshots of another embodiment of the system integrated with agent profile pages within a real estate website;

FIG. 9 is a flowchart outlining a method of implementing a system for two-way communications using SMS technology; and

FIGS. 10a to 10e are example screenshots of another embodiment of chat tool access.

### DETAILED DESCRIPTION

The disclosure is directed at a system and method for online communication, which may be seen as a chat tool, which is embedded within a website which allows visitors to the website to engage in a chat with a website owner or individual associate with the website if they have a question. If such a question arises, the visitor can use the chat tool to communicate with the website owner, agents or affiliates, to hopefully obtain real-time answers to questions the visitor may have.

The website owner is able to use their mobile device (SMS technology) to communicate with the visitor through the chat tool. The chat tool is embedded in the website such that there is no software installed on either the device the visitor is using to access the website or the mobile device, such as a cellular telephone, tablet or watch, with which the website owner is responding.

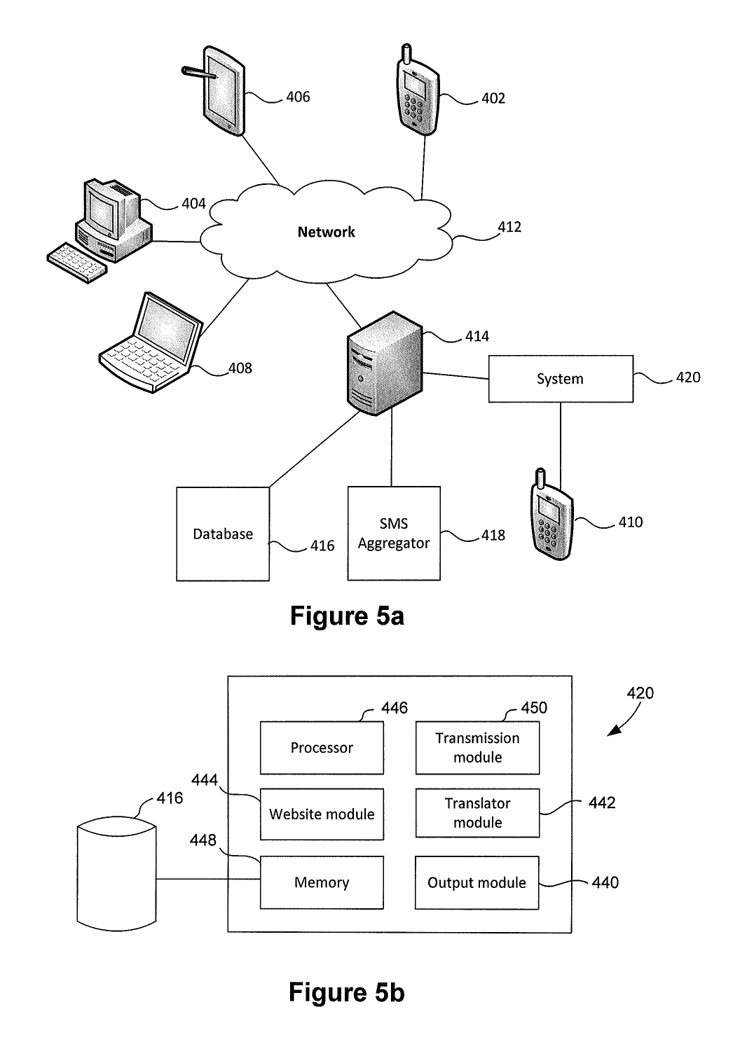

Turning to FIG. 5a, a schematic diagram of apparatus for providing synchronized two way communication between a mobile device and a website platform using SMS technology is shown. In the current embodiment, the apparatus 400 includes different types of participants, namely a user or visitor to a website (represented by mobile device 402, desktop 404, tablet 406 or laptop 408) and an individual or individuals associated with the website (represented by mobile device 410). The user may also use other devices to access the website. The mobile device 402 or 410 may be a cellular telephone or a smartphone or the like.

The apparatus 400 further includes a network 412, such as the Internet, to enable communication between the user and the individual or individuals associated with the website. Other examples of a network include, but are not limited to, a Local Area Network (LAN), a Virtual Local Area Network (VLAN), a Wide Area Network (WAN), a Virtual Private Network (VPN), or the like. A website server 414, a database 416, and a SMS aggregator 418 are also connected directly, or indirectly, to the network 412.

The website or webchat server 414 may store information relating to the implementation of the website or may store the information for the website. The website server 414 may also store the modules or a system 420 for allowing the user to access the content or data which is stored in the database 416. In the embodiment where the website relates to real estate, the database 416 may store data such as, but not limited to, agent information, real estate listing information, contact information etc. . . .

A system 420 may be partly incorporated in the website server 414 or may be configured using a stand-alone network device operatively connected to one or more servers. The operative connection may be via a direct connection or via the network 412. The system 420 may query the database 416 and may retrieve electronic content from the database 416. The system assists in providing a mechanism for connecting a user with the individual associated with the website using an SMS enabled chat tool which is integrated within the website.

FIG. 5b is a schematic diagram of the system 420 for providing synchronized two way communication between a mobile device and a website platform using SMS technology according to one embodiment. The system 420 includes an output module 440, a translator module 442 and a website module 444. The system 420 also includes a processor 446, a memory module 448, and a transmission module 450. The system 420 is also connected with the database 416 or a database module may be incorporated within the system. In one embodiment, the database 416 may store chat histories, user settings or core functions of the system. The database 416 may also store all three of these components. The output module 440 is configured to display the text in the chat tool for the user based on the responses from the website individual or than automated response. The translator module 442 retrieves the information which is being submitted by the user and processes this data for transmission to an individual associated with the website. The website module 444 is configured to communicate with the website owner. The website module also interacts with the SMS aggregator to process messages from the user into SMS format and the SMS messages from the website owner in order to translate the message from an SMS format to a format compatible with the chat tool.

The system 420 further includes the processor 446 which is configured to execute instructions from the other modules of the system 420. In some cases, the processor 446 may be a central processing unit. In other cases, each module may be operatively connected to a separate processor. The system further includes a memory module 448, for example a database, random access memory, read only memory, or the like.

The transmission module 450 is configured to receive and transmit data to and from the network 412. The transmission module 450 may be, for example, a communication module configured to communicate between another device and/or the network 412. The transmission module 450 may receive or intercept a request from a user, via the network, to access the system 420. In some cases, the user request may be directed to the system 420.

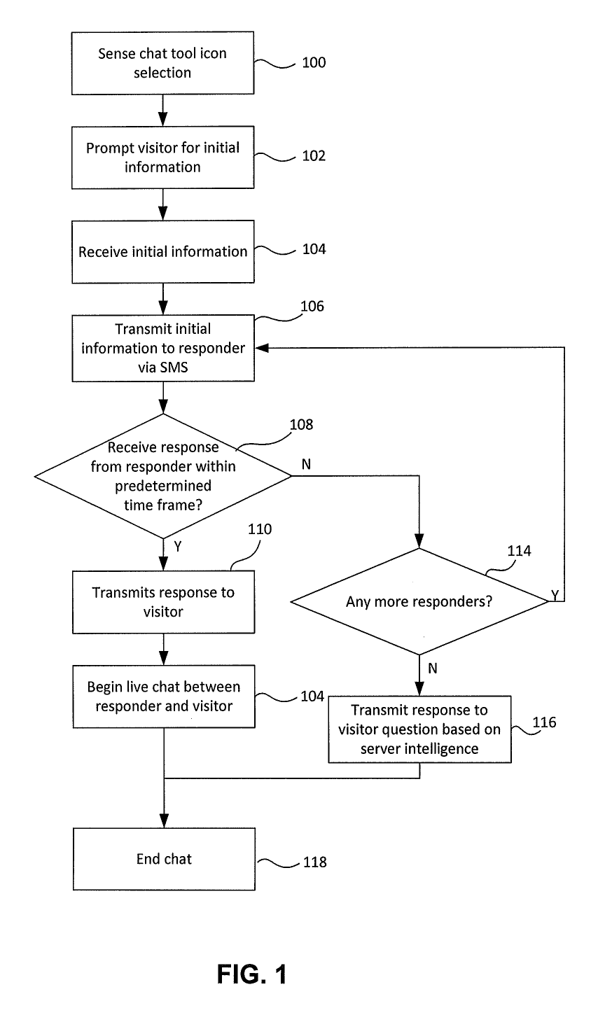

Turning to FIG. 1, a method of providing synchronized two-way communication between a visitor to a website and an individual associated with the website using SMS technology is shown. In other words, FIG. 1 is directed at a method of providing a chat tool for a website.

If a user or visitor to the website wishes to ask the website owner a question regarding information listed on the website, or simply wishes to contact the website owner, the visitor initiates a chat window, or the chat tool, by clicking on an icon representing the chat window. Other ways to initiate the chat window, or tool, are contemplated such as, but not limited to, calling up the chat tool from a footer tray, a link, a display ad or a button. After selection of the chat tool icon is sensed (100) by the server hosting the website or the by the system, the visitor may be prompted to submit initial information or data, such as demographic information (name and/or email) and a question or message they wish to deliver to the individual associated with the website (102). It will be understood that other demographic information may also be requested.

After receiving the initial information from the visitor (which is entered as would be in any chat window) (104), the website server, which may also be seen as the system 420, may process the initial information to determine if the initial information is SPAM. If not, the website server transmits all or a portion of the initial information to a website owner via a webchat server. The webchat server then processes the initial information and transmits this information via a short message service (SMS) message (106) to the website owner's mobile device. The webchat server may also transmit the initial data or information through the SMS aggregator to translate the initial data to SMS format. Although described as separate servers, the website server and the webchat server may be one server. In one embodiment, the webchat server may only transmit the question to the website owner. In another embodiment, instead of the website owner, the question may also be transmitted to a person who the website owner has designated, collectively seen as a responder, to receive questions from visitors to the website. Some advantages of the chat tool of the disclosure include, but are not limited to, the website owner does not have to be logged on to a website to respond; no chat window is opened on the website owner's mobile device; no code needs to be executed, no application needs to be downloaded and installed on the website owner's mobile device and no learning curve to use the chat tool if the website owner is familiar with sending and receiving text messages.

In one embodiment, the transmission of the initial information (106) may be performed in two (2) parts from the website server to the webchat server. The first part describes the location (or web URL) from which the visitor is trying to correspond with the website owner and any other demographic information which was previously submitted (such as in 102). The second part provides the question that the visitor entered. This division may also be performed when the webchat server is transmitting the information, in the form of a SMS message, to the website owner. In one embodiment, the webchat server may be assisted by an SMS aggregator or a mobile aggregator to translate the initial information into an SMS message. In another embodiment, the website/webchat server may separate the information into two parts for transmission to the website owner.

If the webchat server receives a response from the website owner or responder within a predetermined time frame (108), the webchat server transmits the response to the visitor (110), via the website server, and begins a “LIVE” or “real-time” chat (112) between the visitor and the responder. In this chat, the visitor continues to use the chat tool to correspond with the responder while the individual associated with the website responds via SMS technology.

If the webchat server does not receive a response from the individual associated with the website within the predetermined time frame, the webchat server determines if there are any further individuals associated with the website to transmit the initial message to (114). If there are no more responders or individuals associated with the website to forward the initial message to, the webchat server (via the website server) transmits a message stating that the webchat server is answering the visitor's question based on a series of responses to other questions (116) or may select a previously designated automated response. If there are other responders to communicate with, the webchat server may then transmit the initial message to these other responders as designated by the website owner. In one embodiment, if none of the responders in the list are available, the webchat server may decide to re-transmit the initial message to the initial responder (or website owner).

In one embodiment, multiple conversations may occur simultaneously but once the visitor leaves the website, the webchat server initiates a final text message notifying the responder that the visitor has left the conversation and that the chat is closed (118).

If desired, some or all chats may be stored in the database or the webchat server for future reference by interested parties such as an administrator of the website or the website owner. The chats may also be stored on the website server. Data may also be collected relating to the chat statistics and stored in either the database, the webchat server or the website server.

The system of the disclosure provides an advantage over some current solutions in that the system is embedded within the website and does not install any software or executable code on the device accessing the website, such as a computer, a laptop, a smartphone or the like and on the device of the individual responding to the initial message.

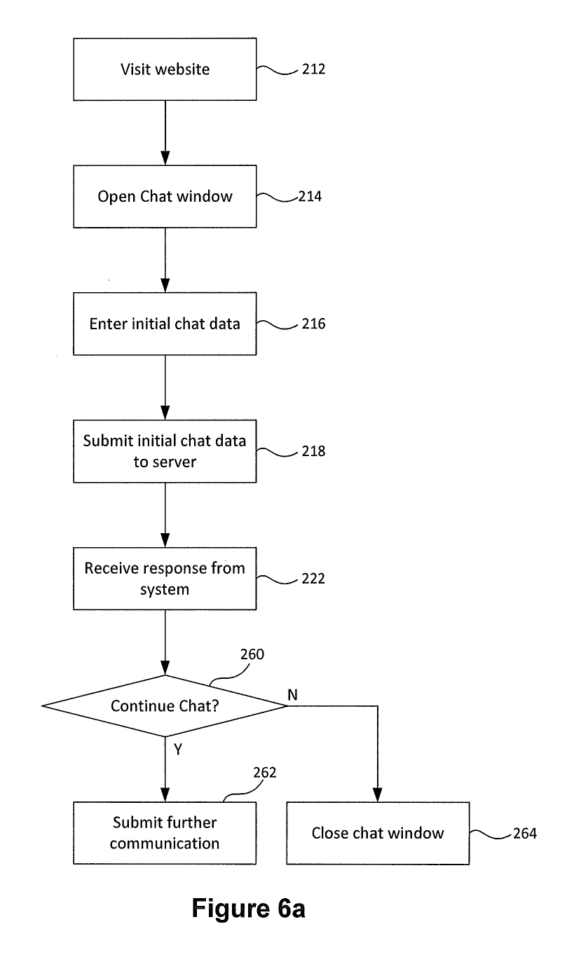

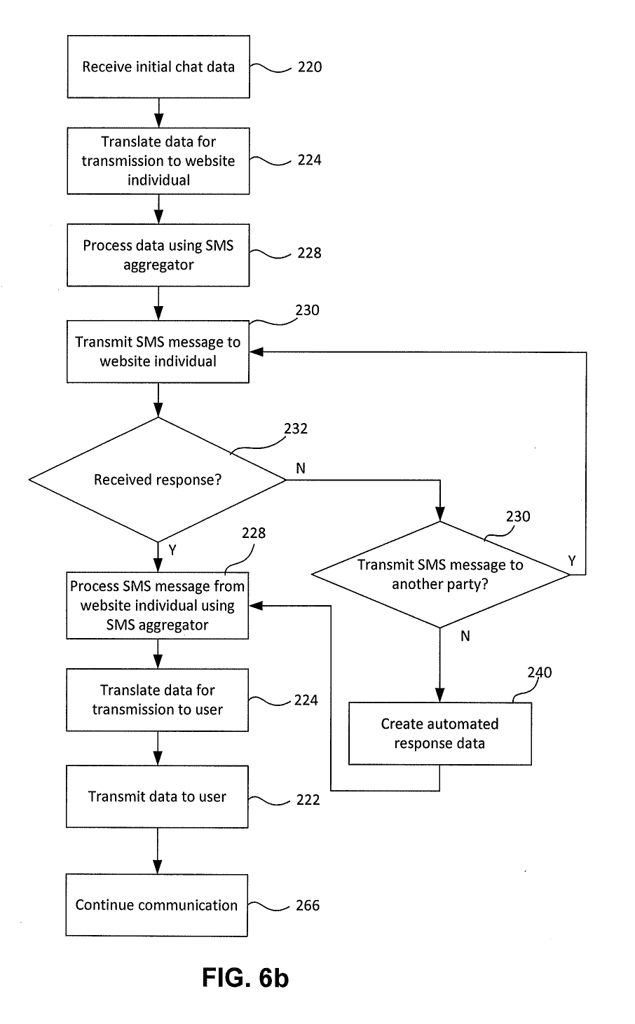

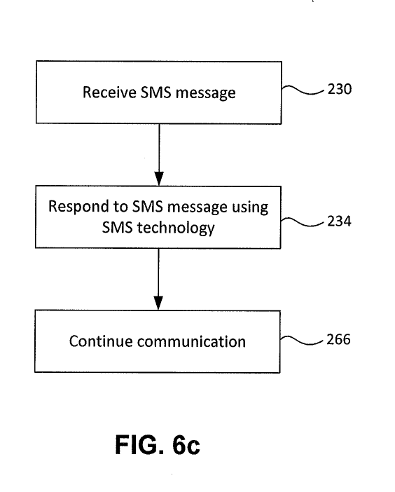

Turning to FIG. 6a, a flowchart outlining a method of user interaction with the system is shown. FIG. 6a shows the actions taken by a user, via their associated device, in relation to initiating and maintaining a conversation with an individual associated with the website being visited.

Initially, the user visits the website (212) where the user may peruse the website to review the information provided on the website. When the user, or visitor, has a question relating to information on the website, the visitor may ask a question using the embedded chat tool, or chat window. As discussed above, an advantage of the system is that there is no software installed on the user's device. The visitor opens a chat window (214) by clicking on an icon or by any other known method.

In order to start communicating via the system, the visitor may be requested (such as by the system or the server) to enter demographic information, such as an email and/or their name, along with a question that they wish to ask the website owner or the individual associated with the website (216). The demographic information and question may be seen as initial data or initial information. This initial data (218) is then submitted to a webchat or website server associated with the chat tool or chat tool application. Eventually, the user receives a response (222) to their question via the webchat server or website server. The response may be from an individual associated with the website or may be an automated response which is generated when no individual associated with the website is available for two-way communication via SMS.

The user may then determine (260) if they wish to continue the chat and if they do, they can submit further communication language (262), otherwise the chat window may be closed (264).

Turning to FIG. 6b, a flowchart outlining a method of providing a chat tool using SMS shown. FIG. 6b shows the actions taken by the system in relation to initiating and maintaining a conversation between a visitor to the website and an individual associated with the website.

Initially, the system receives data from the user (220). This data may be a request for the initiation of a conversation between the website visitor or user and an individual associated with the website or website owner or may be a response from the user to a request for data from the system. If the data received is a request for the initiation of a conversation, the system may transmit a request to the user to submit demographic information and their question for the individual associated with the website. After receiving the initial data from the visitor, the system then translates the data (224) for transmission of the initial data to the individual associated with the website. The translation of the data may include ensuring that the initial data is not SPAM. After processing, the processed initial data, preferably in string format, is then transmitted to a SMS aggregator which then further translates this data (228) into an SMS message. After this processing, the SMS message is then transmitted to the website owner's mobile device or SMS-enabled device (230). The SMS aggregator sends the message through a set of networks (data carriers) to reach the website owner's mobile device. In other words, the SMS aggregator may act like an information network.

A check is then performed to see if a response is received from the website owner (232). If a response is received, the SMS response is then translated (228) by the SMS aggregator and then processed (224) by the system before being transmitted back to the user (222) in a format readable by the chat tool.

If no response is received, the system may decide to transmit the SMS message to another party (230) associated with the website. If the system decides not to transmit the SMS message to a further party, an automated response is created or selected by the system (240). This automated response is then translated (228) by the SMS aggregator and then also processed (224) by the system before being transmitted back to the user (222). The conversation may then end or further communication may be performed (266). Unlike other current systems, the system and method of the disclosure is enabled using SMS technology which allows the individual associated with the website to use SMS technology to respond to user questions without requiring a data or wi-fi connection.

Turning to FIG. 6c, a flowchart outlining a method of website owner or individual associated with the website interaction with the system is shown. The method of FIG. 6c assumes that the website has already been created and that the chat tool has already been integrated within the website as outlined in the current specification.

The website owner receives an SMS message (230) from the system which includes a question and demographic information relating to a visitor to the website. In a real estate environment, the question may relate to a listing on the website. After receiving the SMS message, the website owner responds to the SMS message (234) using SMS technology on their cellular phone or SMS-enabled device. The system then performs the necessary processing of the SMS message from the website owner and transmits it to the visitor. A conversation may then be initiated between the website owner and the visitor to the website with the website owner using SMS technology to communicate to continue the communication (266).

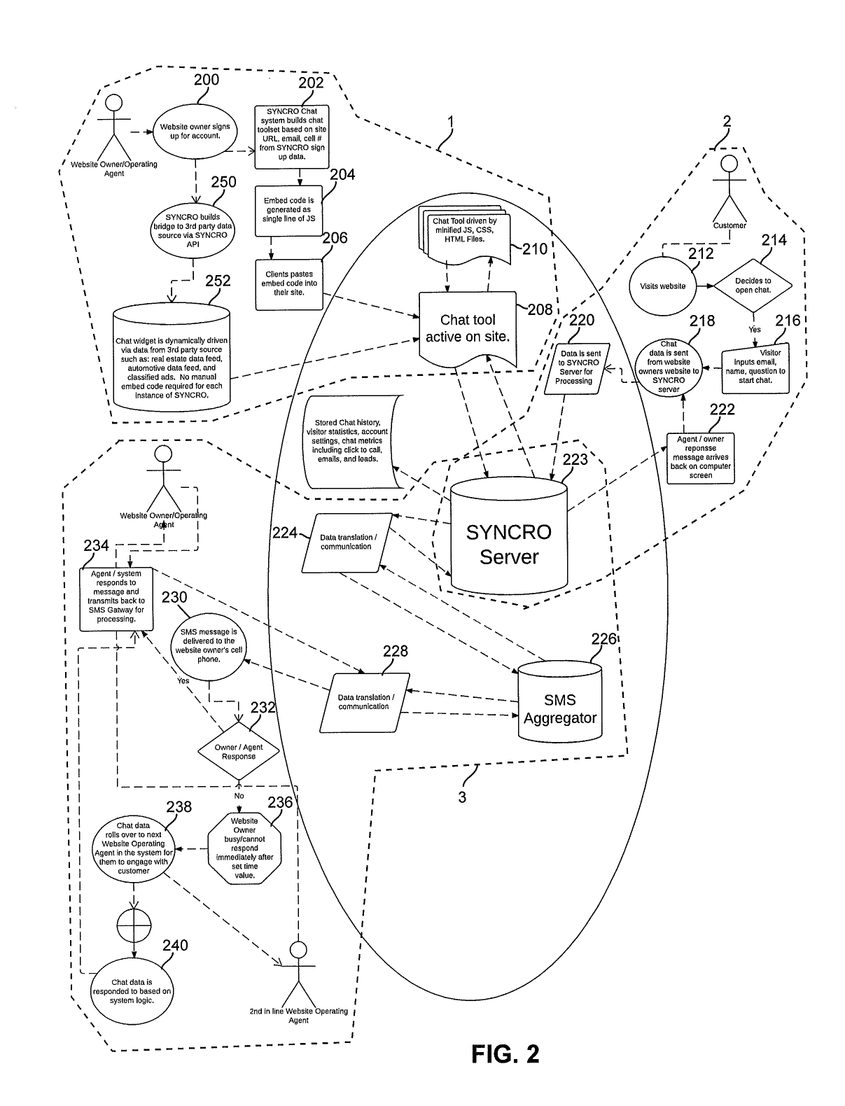

Turning to FIG. 2, a schematic diagram of a fully integrated method and system for a chat tool is shown. In FIG. 2, there are various boxes representing actions which are being performed. This will be described in more detail below. In this figure, there are multiple sections of operation which have been referenced as sections 1, 2 and 3 for simplicity. Although they are shown and will be described as separation sections, there is some interaction between the sections as will be discussed.

Section 1 relates to the implementation of a website which includes a chat tool or window that is integrated or embedded within the website unlike some current solutions which require chat window software to be installed on devices accessing the website when a visitor to the website wishes to communicate using the chat tool.

Initially, the website owner has to sign up for a website account by registering for a domain name. If the website is being used in the real estate environment, the website owner may be seen as an operating agent (200). As understood, this is a standard process for hosting a website and therefore is necessarily performed and not a part of the novel process for providing the chat tool. After obtaining a domain name, a chat window application, or system, may be built (202) which includes, but is not limited to, a chat toolset based on the uniform resource locator (URL) of the domain name and other assorted information such as email contact information for the website owner or a mobile device number for the website owner, or both.

The website owner may then access or request code for the chat tool. Code for implementing the chat tool within the website may then be generated (204) and transmitted to the website owner such that it can be included within the webpage code for the website. In one embodiment, the code may be generated upon request and may be obtained from a website owner's account or the code may be emailed to the website owner. In the preferred embodiment, the chat tool or chat window code is generated using a computer language such as Javascript™.

The website owner can then insert the generated code into the code for developing the website (206) which provides the chat window icon when a visitor accesses the website. In other words, once the generated code is added to the webpage code, it can be deemed that a chat tool is active on the website (208) once the website is accessible. The chat tool may be driven by minified Javascript, Cascading Style Sheets (CSS) or HTML files (210)

In another embodiment, after the website owner obtains the domain name, the code may be dynamically driven by an application program interface (API) (250). In this embodiment, a bridge may be created to a third party data source via the API and then a chat window (or widget) may be dynamically driven from the 3^{rd} party source (252). For example, the 3^{rd} party source may be a real estate data feed, an automotive data feed or classified ads. In this embodiment, the chat tool may be realized without the need to embed code within the webpage code. Therefore, once the bridge is created, the chat window may be available if a visitor selects the 3^{rd} party data source in the website.

Section 2 relates to the actions being performed when a visitor to the website wishes to use the chat tool. Typically, the chat window may be used for a visitor to communicate with the website owner such as to ask a question relating to information available on the website. In the real estate environment, the visitor may use the chat window to speak to the website owner or property listing owner which is determined by the bridge between the webchat server and the 3^{rd} party real estate data feed about certain characteristics of a listing on their website. Other examples in which the chat tool may be beneficial include, but are not limited to, the automotive sector where the chat tool may be used to discuss details about vehicles as sales agents are often out in the car lot or classified ads where people can post an ad about their product and have interested parties (visitors) ask them questions without needing to post their contact information such as it is with current classified ad websites. This allows the person selling to keep the phone number confidential as the chat tool is used as the bridge for communication. Also, the chat tool may find use in display ads where visitors may select a display ad and be engaged directly with an advertiser.

When a visitor visits the website (212), the user may peruse the website to review the information provided on the website. When the visitor has a question relating to information on the website, the visitor may ask a question using the embedded chat window. The visitor opens a chat window (214) by clicking on an icon or any other known method.

In order to start communicating via the chat window, the visitor may be requested to enter demographic information like an email and/or their name along with a question that they wish to ask the website owner (216). The demographic information and the question may be seen as initial chat data or initial information. This initial chat data (218/220) is then submitted from the website (or the website server on which the website is housed) to a webchat server associated with the chat window, or chat window application. Eventually, the webchat server transmits a response (222) to the visitor (as will be described with respect to Section 3) via the chat window.

Section 3 is directed at the interaction between a website owner, website owner designates or responders, with the webchat server (223).

After the initial data is received by the webchat server, the initial chat data is translated, processed or deciphered (224). Part of the translation, processing or deciphering may also include ensuring that the initial data is not SPAM. In this translation, processing and/or deciphering, the question from the initial data is also translated into an SMS message for delivery to the SMS-enabled device of the website owner. After processing, the processed initial chat data, preferably in string format, is then transmitted to a SMS aggregator (226) which then further processes this data (228). The SMS aggregator sends the message through networks (data carriers) to reach the website owner's mobile device. In other words, the SMS aggregator may act like an information network.

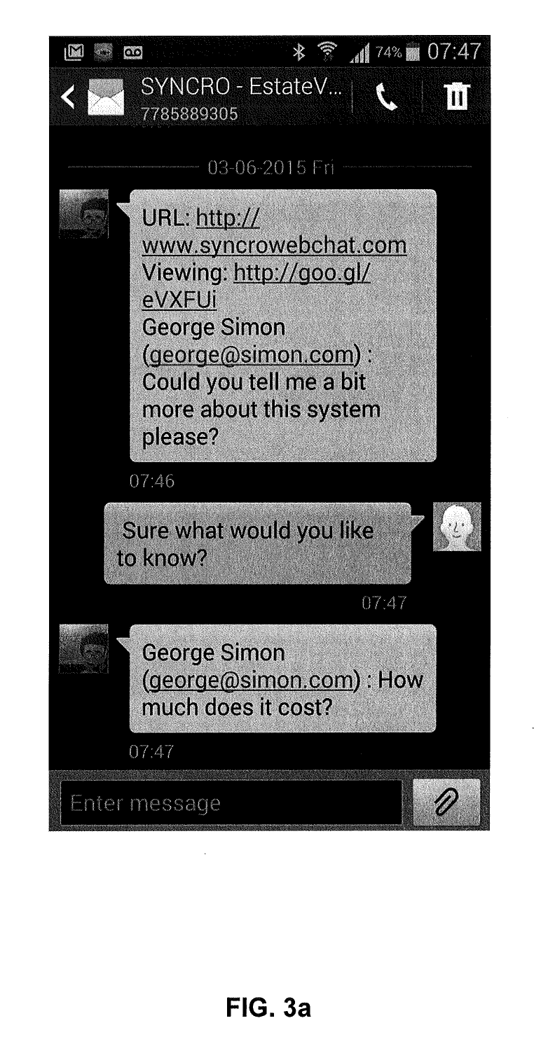

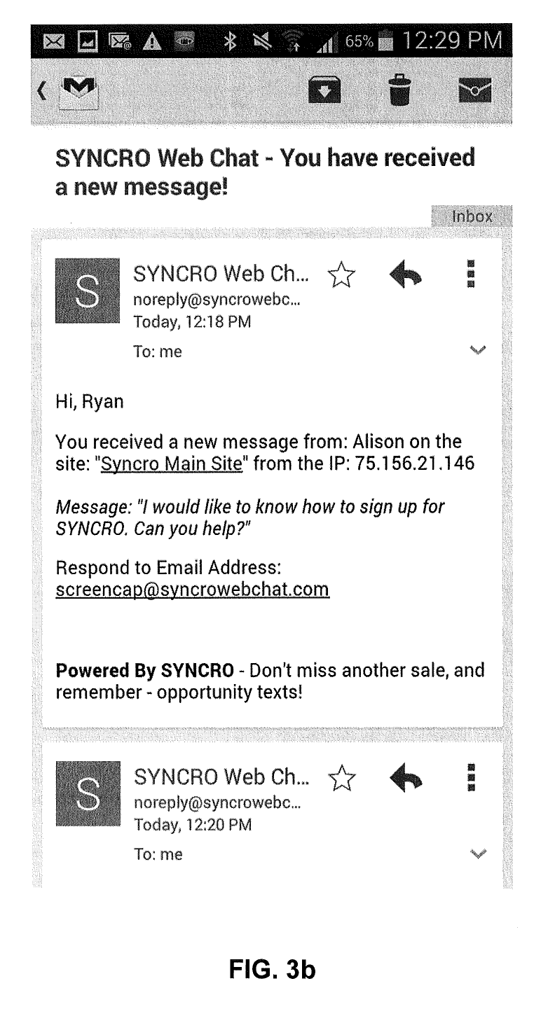

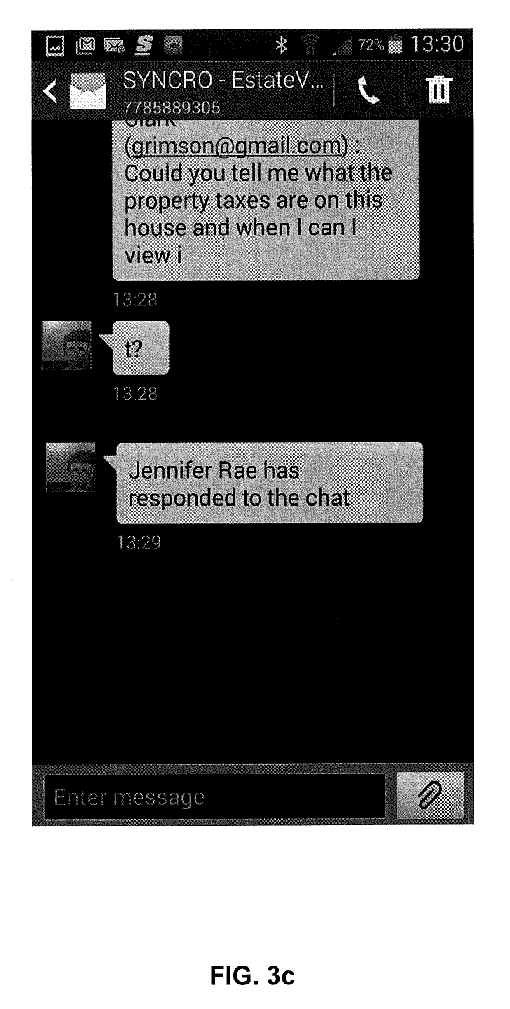

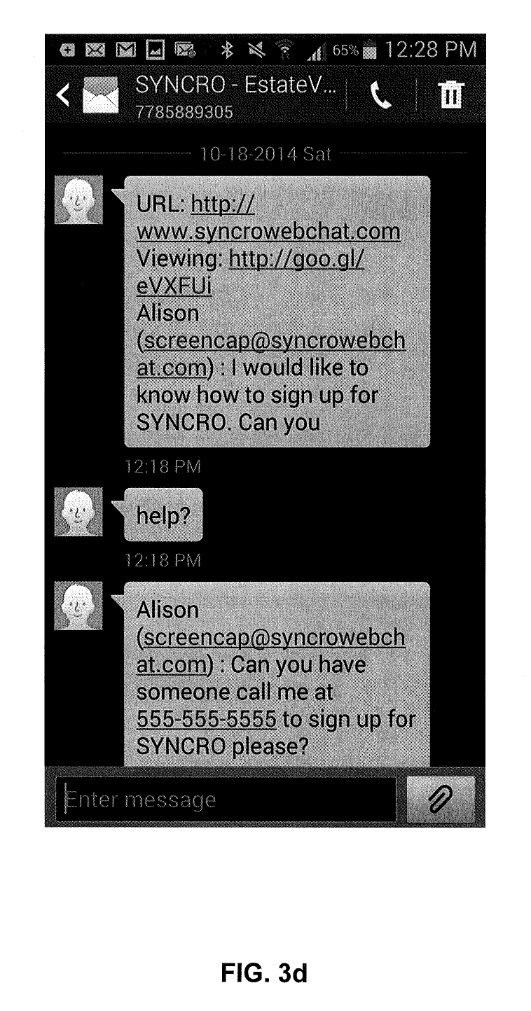

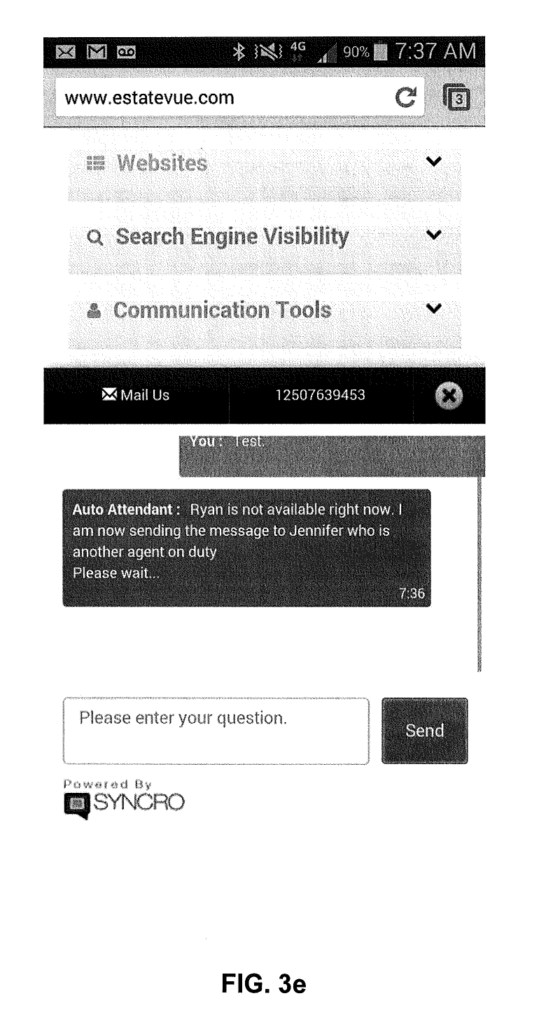

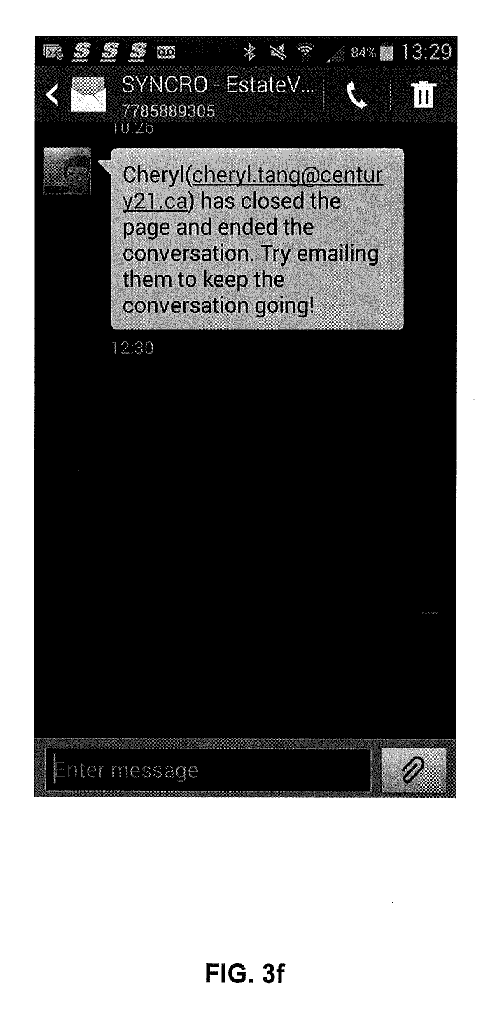

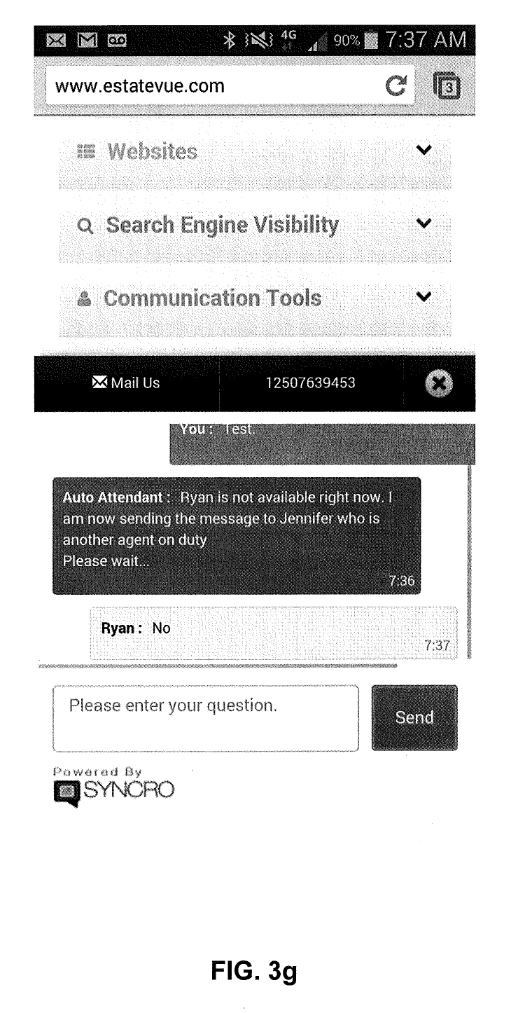

After this processing, the SMS message is then transmitted to the website owner's mobile device (230) so that the website owner may be able to respond to the question. An example screenshot of what a website owner may see is shown in FIG. 3a. Another example is shown in FIG. 3d. FIG. 3a also includes further conversation between the website owner and the visitor. The website owner is able to see the URL of the website that the visitor is viewing, the name and email of the visitor and also the question from the visitor. In seeing the URL, the website owner is able to understand which specific page on the website that the visitor is viewing or initiating the chat window from in order to provide an intelligent response especially when the website includes multiple pages in which the chat tool is active. In order to provide further notification to a website owner, the website owner may be sent an email indicating that a chat has been commenced. An example screenshot of this email is shown in FIG. 3b. In another embodiment, the SMS message may also disclose if the chat has been transmitted to another responder or if the chat window has been closed (as described below).

If the website owner is available to respond (232), the website owner enters a text message response (234) into their SMS-enabled or mobile device which is then sent back to the SMS aggregator (or SMS gateway) for processing and delivery back to the visitor via the chat window (222).

After entering the responsive text message (234), the SMS message from the website owner is then transmitted back to the webchat server for processing (224, 228) (such as to translate the SMS message into a format which is capable to be read within the chat window by the visitor). This translated message is then sent to the chat window (222). The chat may then continue between the visitor and the website owner with the webchat server and the SMS aggregator performing the necessary translations or processing between the chat window and the mobile device or SMS communication.

Alternatively, moving back to the delivery of the initial chat data to the website owner, if the website owner is unable to respond to the SMS message (based on the initial data) (232) after a predetermined amount of time (236), the SMS message may then be forwarded to another individual (238) who is previously designated by the website owner to receive messages when the website owner is unable to respond. If the responder is able to respond, the website owner may be transmitted a message alerting the website owner of this action. An example screenshot of what the website owner may see is shown in FIG. 3c. The website owner designate or responder, may then respond to the question from the visitor by typing a text, or SMS, message response into their mobile device (234) which is then transmitted to the SMS gateway for processing and returned to the chat window (such as disclosed above with respect to a response from the website owner). In another embodiment, instead of transmitting the SMS message to the website owner designate, a response to the visitor may be generated using system logic (240) or a message may be transmitted back to the visitor indicating that the website owner is not able to respond but will do so at a later time (such as schematically shown in FIG. 3e). The visitor may see the example screenshot of FIG. 3g. This automatically generated message or response may then be transmitted back to the SMS gateway for processing before being delivered to the visitor through the chat window in the website.

When a visitor closes the conversation, the website owner or the responder may receive a message on the mobile device indicating that the conversation is closed, such as schematically shown in FIG. 3f.

As discussed above, the webchat server may also store chat histories, visitor statistics, account settings or chat metrics, or any combination of such information within a database.

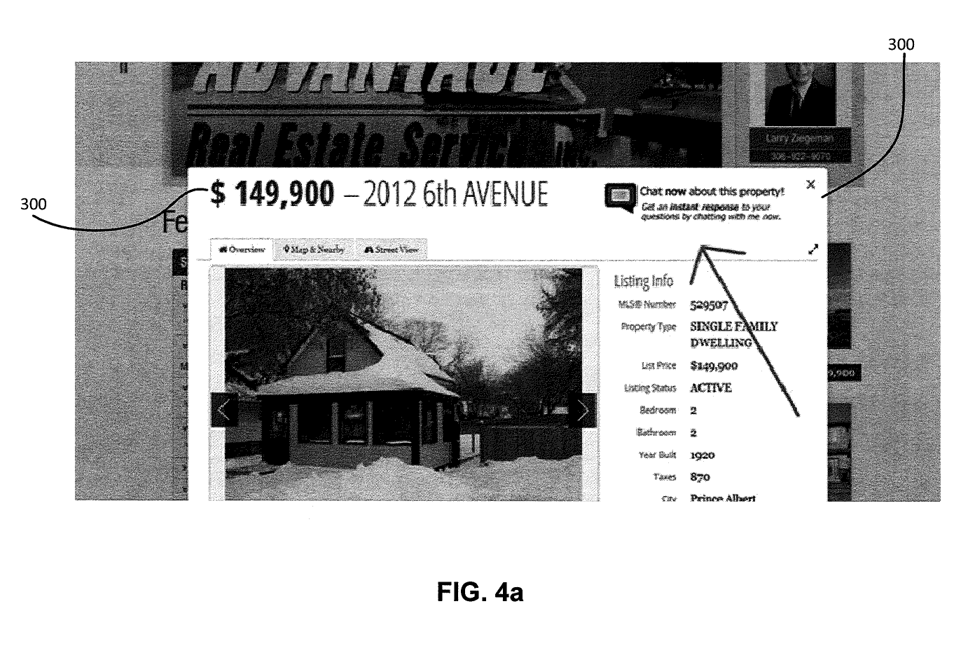

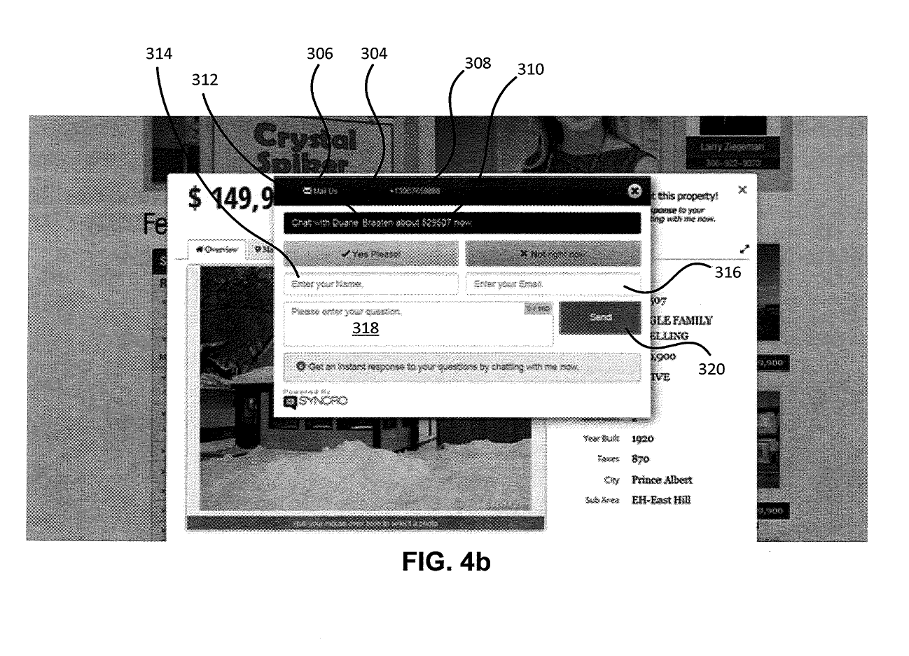

Turning to FIGS. 4a and 4b, screenshots of what a visitor may see when they are visiting a website are shown. In the current figures, the screenshots relate to a chat tool for use with a real estate feed. When accessing the website, the visitor may decide to access a chat tool 300 when viewing a screen 302 providing information about a house property. In one embodiment, the chat tool is provided to the visitor is the house property has a cellular telephone number associated with it but if not, the chat tool may be associated with a cellular telephone number of the website owner or a number that is stored in a database. Alternatively, if the house property belongs to a real estate agent who is associated with the website, the chat tool may be provided on the screen but if the house property does not belong to a real estate agent who is associated with the website (or brokerage associated with the website), the chat tool may connect the visitor to any agent associated with the brokerage.

Turning to FIG. 4b, a first embodiment of a screenshot of what the visitor will see when they click on the chat tool icon of FIG. 4a is shown. In FIG. 4b, a pop-up window 304 or form, is displayed which includes information such as, but not limited to, an email icon 306 whereby the visitor may email the real estate agent, the real estate agent's telephone number (which may be a cellular or landline number) 308, information about the house property that the user is interested in 310 and the real estate agent's name 312. The visitor is also requested to enter their name in a name box 314, their email in an email box 316 and question in a question box 318. The information associated with the house property and the real estate agent (such as the real estate agent's telephone number, the real estate agent's name etc.) is driven by a real estate data feed.

After the visitor has completed the form, the visitor can send the chat data by clicking on a Send button 320. After clicking the Send button, the initial chat data is transmitted to the real estate agent (or website owner and the like) and the conversation may be started (such as described above). In this embodiment, one advantage is that the chat tool is initiated within the house property screen.

Some further advantages of the general chat tool of the disclosure include, but are not limited to 1) the chat tool is integrated within a website with a limited amount of code; 2) the chat tool is not required to be downloaded and installed into browsers or devices for operation as the chat tool is controlled and hosted by a webchat server without any installation required; 3) the chat tool may have the chat window called from various mechanisms such as web based graphics, links, third party data sets and specialized code; 4) the chat tool may be designed to send the messages to several owners of the site if one owner is not able to respond in predetermined timeframe; 5) the chat tool may be designed to respond on behalf of the website owner if specific criteria are met; 6) spam filtering algorithms may reduce or eliminate abuse of the chat tool; 7) the chat tool uses an initial SMS message which defines what URL the visitor is viewing, their name and email; and 8) the chat tool uses a closing SMS message which is sent to a website owner if the visitor is no longer viewing the website or actively engaged in the chat.

Another advantage of the system is that the system includes intelligent SMS notifications whereby the intelligence that is being developed is based upon data that are either: a) already in 3rd party data systems or b) a series of questions that have answers provided in the database. The system reads the question that is asked by the website visitor, and if there are specify key words in the question, it will preferably provide a response that meets the users needs. For example, if the webchat server is connected to a real estate data feed, and someone initiates a chat that poses the question: “What are the taxes on this property?”. If the data is in the system, the webchat server may provide an answer instead of transmitting the question to the website owner or others.

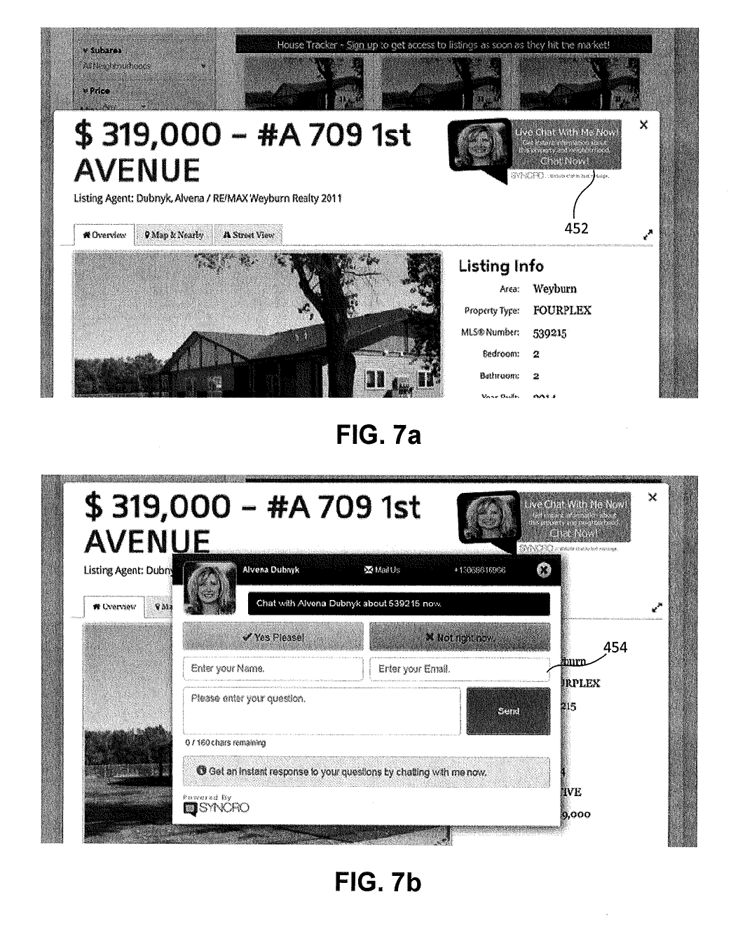

Turning to FIGS. 7a and 7b, another embodiment of the disclosure is shown. In the current embodiment, the chat tool or chat window, may be integrated within real estate listing information in a real estate website. The listing information may relate to a single agent site, a broker or even within a banner which is displayed on the website. As will be understood, with other websites, the chat window may be integrated within a specific section of the website and does not have to be a stand-alone chat window or tool. As shown in FIG. 7a, the chat tool is integrated within a listing for a home and can be accessed via a click of a button such as the one located at a top of the webpage or website. By clicking on a “Live Chat with Me Now!” button 452, an initial chat window 454 requested initial data, such as, but not limited to, name, email, and a question may be displayed by the system to the user (such as schematically shown in FIG. 7b). As can be seen in the dialog box in FIG. 7b, the system includes information associated with the listing within which the chat window is integrated. This provides the advantage that certain information relating to a user's question may be automatically and quickly retrieved and associated with the chat or communication using SMS without requiring further user input.

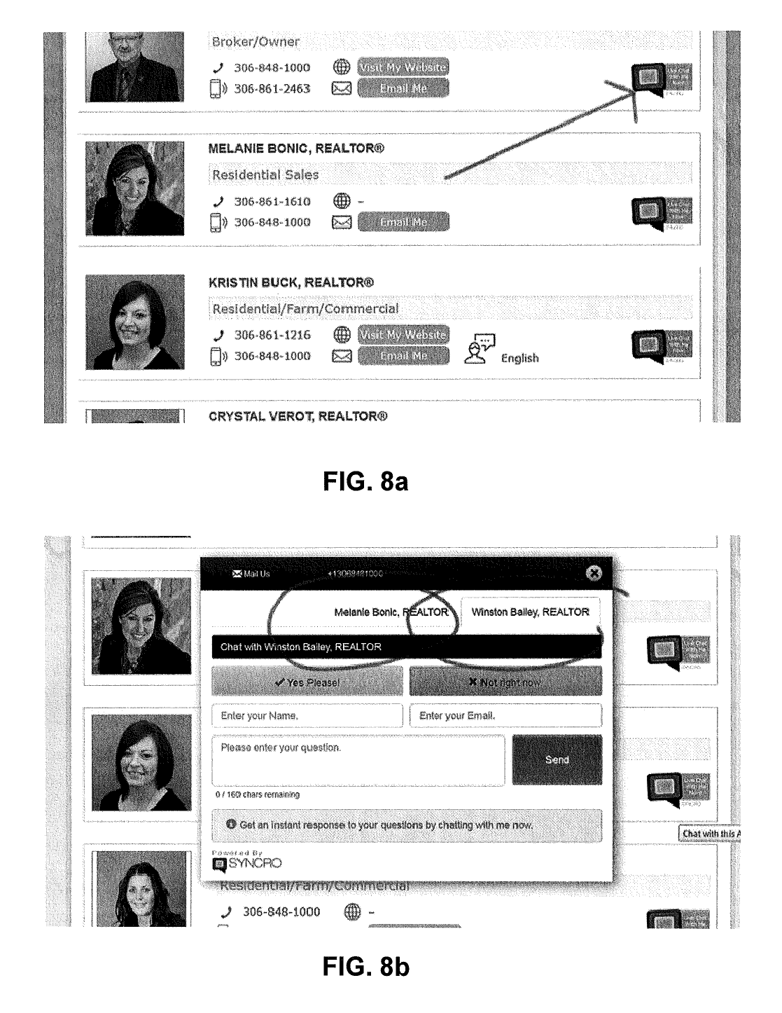

In another embodiment, as shown in FIG. 8a, the chat tool may be integrated in a profile associated with an individual associated with the website. For instance, in a real estate website, the chat tool may be integrated within an agent's profile such that a visitor to the website may be able to click on or initiate a chat from the agent profile page. In another embodiment, as shown in FIG. 8b, a visitor may have the opportunity to speak with multiple individuals associated with the website in separate conversations. The dialog box in FIG. 8b provides an opportunity for a visitor to enter their demographic information and their question and have it delivered to the selected agent via SMS in order to engage in two-way communication. In this example, the user may be able to have two conversations at the same time with two different individuals.

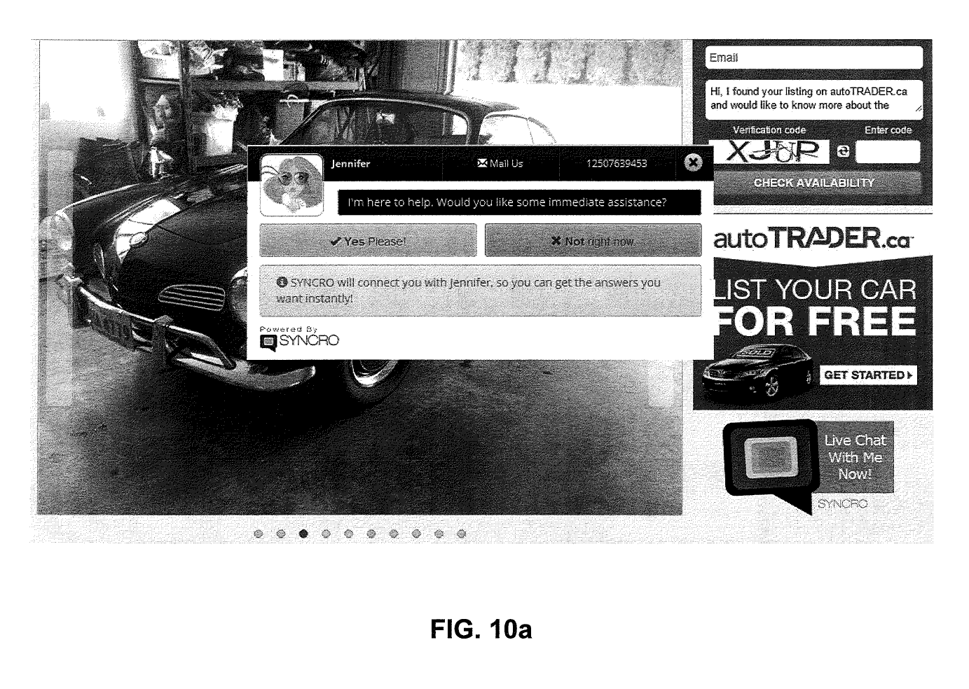

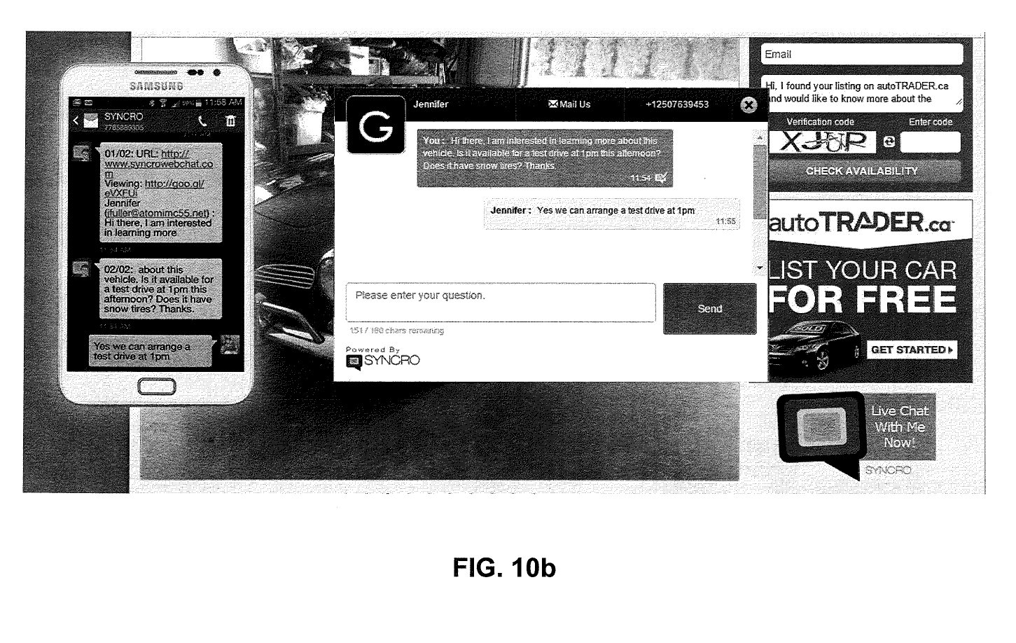

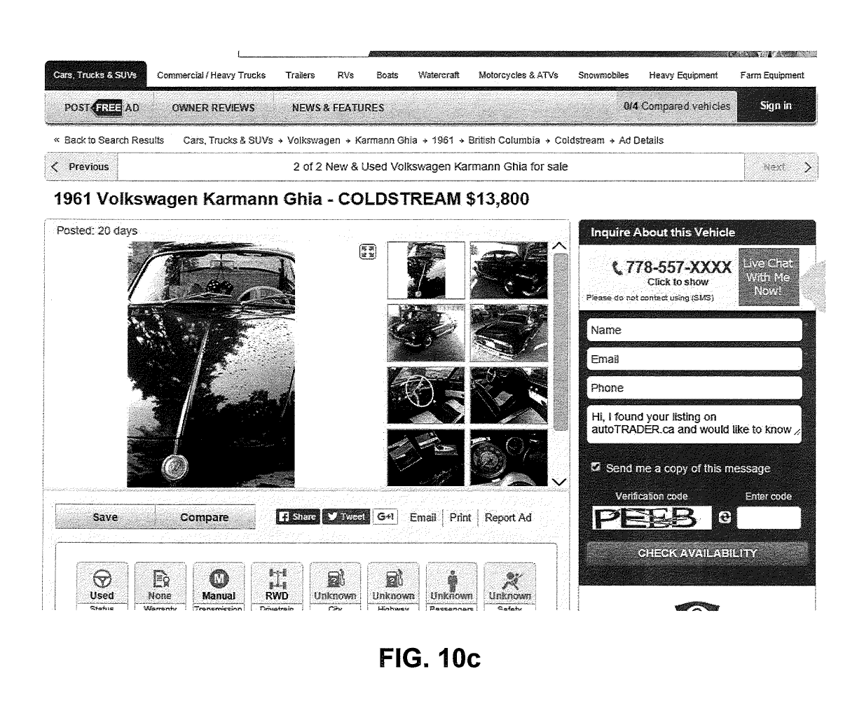

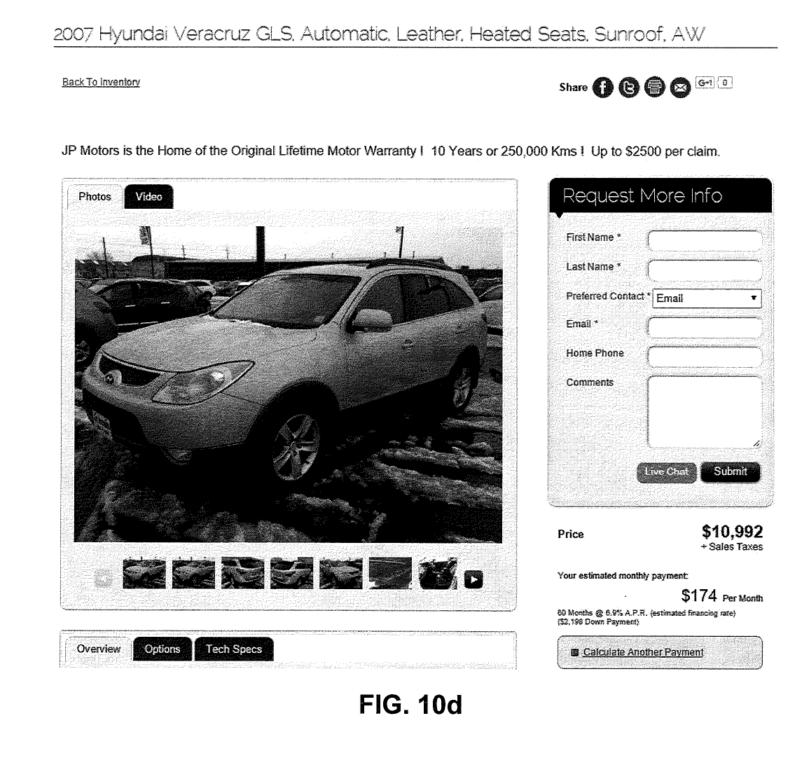

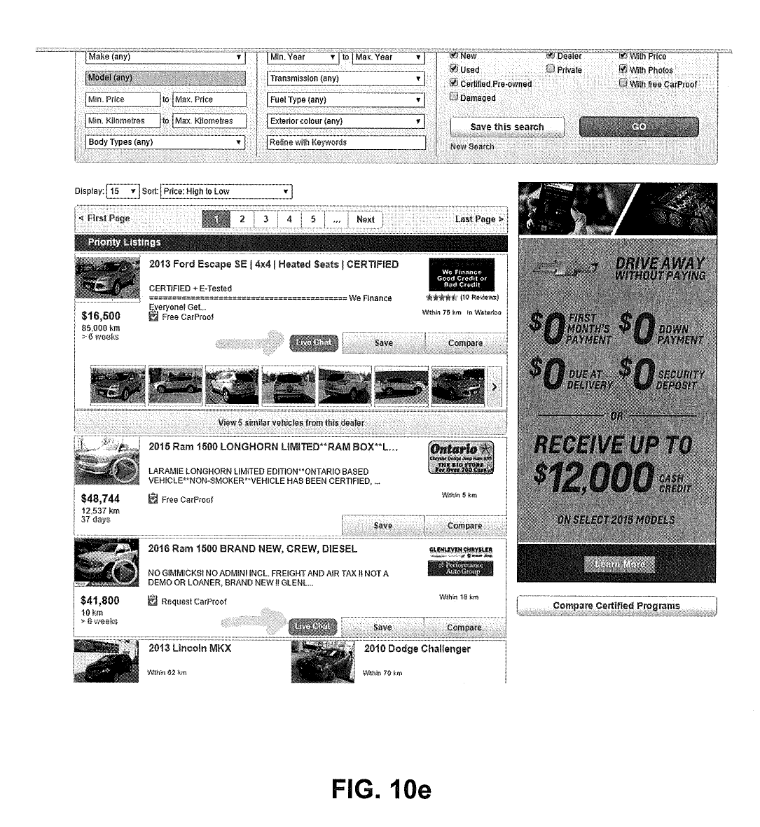

Turning to FIGS. 10a to 10e, example screenshots of the system of the disclosure being integrated within a website associated with automotive sales is shown. In FIG. 10a, the user or visitor to the website is able to engage in two-way communication with an individual associated with the website upon initially accessing the website. If the user decides to communicate with the individual, the communication is transmitted via SMS technology to the individual after the user enters initial data. In FIG. 10b, the example screenshot shows a conversation between a user and the individual associated with the website. FIGS. 10c to 10e provide screenshots showing where a button to initiate communication may be integrated within the automotive website.

One advantage of the current system is that a user or individual associated with the website does not have to be “logged on” to be able to use the system. As the system uses SMS technology to connect with the individual associated with the website, the individual simply has to have their phone on in order to receive the initial data. Also, another advantage of the system is that when a user wishes to initiate two-way communication, the communication is tied directly to a specific individual associated with the website which allows the individuals associated with the website to know that if a request for communication comes in from a user, the user wishes to have a direct conversation with the individual associated with the website.

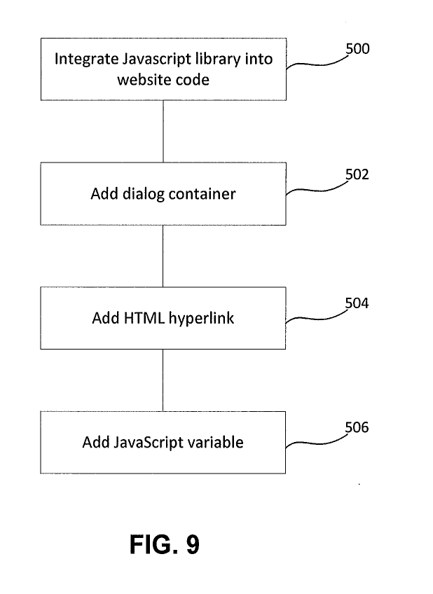

Turning to FIG. 9, a method of implementing or integrating a chat to text tool is shown. Initially, a Javascript library is to be integrated into website code (500). In a preferred embodiment, the Javascript library may be integrated using the code:

<script src=http://beta.syncrowebchat.com/is/v2/embed.js></script>

which is preferably included prior to the </body> tag.

A dialog container is then required to be added (502) such as by using the code:

<div id=“syncro-webchat”></div>

In order to provide the button or the apparatus to allow the chat tool top be triggered, an HTML hyperlink is added (504). An example of code for adding the HTML hyperlink may be:
<a href=“javascript:void(0)” class=“powerlinks”
id=“syncro-402b917853d0d02a45232e3d23b896aa”
data-shortname=“your-site-shortname”
data-title=“Chat with |*Admin Name*|”
data-description=“Chat with the realtor about this particular listing”
data-mobile-no=“+155591000”
data-admin-name=“John Doe”
data-admin-email=“sigit@atomic55.net”
data-cta-no=“+1500200”
data-realtor-id=“55190190”
data-use-realtor-settings=“true”
data-history=“force_different_page”
data-page-id=“page-918”>
Chat with the Realtor</a>

The properties of the HTML hyperlink are outlined below.

class (required) In order for the chat tool to identify the hyperlink as a trigger, the class property must include “powerlinks”.

Default: powerlinks

id (required) This is the powerlinks ID. The user should get this on the Manage Powerlink Page on the chat tool admin, or may be generated randomly. Each powerlinks should have its own static ID (ID for each powerlinks shouldn't change from time to time)

Default: none

data-shortname (required) This is the user's chat tool instance shortname and can be found on the Manage Sites Page on the chat tool admin.

Default: none

data-title (optional) The text on the top of chat tool window. There are several shortcodes to be used:
   |*Client Name*|
   |*Client Email*|
   |*Subject*|
   |*Admin Name*|
   |*Admin Phone*|
   |*Admin Email*|

Default: The Call to Action Title set on the Site Settings page in the chat tool admin panel.

data-description (optional) The text on the bottom part of chat tool window.

Default: The Description set on the Site Settings page in the chat tool admin panel.

data-mobile-no (optional) The mobile phone number to which the chat message will be sent.

Default: The Texting Phone Number set on the Site Settings page in the chat tool admin panel.

data-admin-name (optional) The name of the responder that will be displayed on chat tool window.

Default: The Responder Name set on the Site Settings page in the chat tool admin panel.

data-admin-email (optional) The email address to which the incoming chat message notification will be sent.

Default: The Email set on the Site Settings page in the chat tool admin panel.

data-cta-no (optional) The call to action number displayed on the head of the chat tool window.

Default: The Call to Action Phone Number set on the Site Settings page in the chat tool admin panel.

data-realtor-id (optional) There are times when the chat tool may override the responder name, mobile, or email address with the ones belong to a realtor is another party is contacted. The chat tool provides an easy method to achieve such thing. A new realtor profile/data may be added in the chat tool admin panel, and specify the Crea Code/Realtor ID as a powerlinks attribute. The chat tool may use the realtor profile specified in the admin panel instead of the one from the <a> attributes.

Default: none

data-use-realtor-settings (optional) In the chat tool admin panel, if a realtor profile is tied to a chat tool child user, and a site settings is assigned to that user, the chat tool provides a method to load that user's site settings for the powerlinks.

This site settings (Auto Responder, Chat Rollover, etc) will override the parent user's default site settings. To do so, the value of this attribute (data-use-realtor-settings) is set to true.

Default: none/false

data-history (optional) By default, the system stores the history of a conversation for 1 hour. The history will be displayed on whatever web page on which the system is loaded. To disable this behavior and allow the system to only load the history on the same page the conversation is initiated, the attribute value is set to force_different_page and the value of data-page-id properly is reset as discussed below.

Default: none

data-page-id (optional) If the value of data-history is set to force_different_page, a specific static ID may be required for all the web pages on which the system or chat tool is loaded and assign the value to the data-page-id attribute.

Default: none

A javaScript Variable is then added (506). In a preferred embodiment, the variable is named syncrowebchat with a JSON object assigned to it. Code for adding the JavaScript variable may be:

<script type=‘text/javascript’>
var syncrowebchat = {

syncro_override_top_position: 100,

powerlinks_use_site_shortname: true,
force_history_on_different_page: true,

powerlinks_minimize_mode: “side”,

extradata: {

mls: ‘C109871’,

address: ‘123 Wellington Avenue, Kelowna, BC’,

title: ‘123 Wellington Avenue’,
price: ‘$425,600’,

agent: ‘Sigit Noviandi’,

thumbnail: ‘http://domain.com/listing-thumbnail.jpg’

}

};
</script>

All of the JSON items are explained as follow.

syncro_override_top_position (int) (optional) When the chat dialog is being displayed, the system or chat tool calculates a window size and brings the dialog box to the very center of the screen. If the chat tool positioning behavior is to be overridden, an integer value is assigned to this JSON item. In the example above, 100 is the distance (pixels) from the top of the web page to the chat tool dialog box.

Default: none

powerlinks_use_site_shortname (bool) (optional) This option is used to let chat tool or system use the site shortname specified on each hyperlink tag instead of the global site shortname.

Default: true (recommended)

force_history_on_different_page (bool) (optional) If you set the powerlinks hyperlink “data-history” attribute to force_different_page, this value is to be set to true.

Default: none (recommended)

powerlinks_minimized_mode (string) (optional) If the chat tool chat window is to be minimized to a side of the page, this value may be set to side.

Default: bottom

extra_data(JSON) (optional) You can pass additional information to the system using this option.

The information will be displayed on the Conversation History Page in the chat tool admin panel. The value of each JSON item in this option should be a string.

Default: none

Another advantage of the system is that the system provides a chat/conversation statistical analytics for a property brokerage. In order for your listings and agents to be included within the analysis process, the following code may be included in the extra data variable:

<script type=‘text/javascript’>
var syncrowebchat = {

extradata: {

mls: ‘C109871’,

address: ‘123 Wellington Avenue, Kelowna, BC’,

title: ‘123 Wellington Avenue’,
price: ‘$425,600’,
agent: ‘Sigit Noviandi’,

```
  thumbnail: ‘http://domain.com/listing-thumbnail.jpg’
  }
};
</script>
```

The above-described embodiments are intended to be examples only. Alterations, modifications and variations can be effected to the particular embodiments by those of skill in the art without departing from the scope of intended protection.

What is claimed is:

1. A method of two-way communication comprising:
receiving request for initiation of two-way communication;
requesting user information from a first party;
transmitting user information to a second party via short message system (SMS) technology;
receiving a second party response from the second party; and
initiating two-way communication between first party and second party by transmitting second party response to the first party.

2. The method of claim 1 wherein receiving response comprises:
determining that the second party is not available for two-way communication;
transmitting the user information to a third party;
receiving a third party response from the third party;
assigning the third party response as the second party response; and
assigning the third party as the second party.

3. The method of claim 2 wherein receiving response further comprises:
determining no party is available for two-way communication; and
assigning an automated response as the second party response.

4. The method of claim 1 further comprising:
continuing two-way communication between first party and second party where communication with the second party is via SMS technology.

5. The method of claim 1 wherein transmitting user information to the second party comprises:
receiving user information from first party;
translating user information via a SMS aggregator; and
transmitting translated user information to the second party.

6. The method of claim 5 wherein the user information comprises user demographic information and a user question.

7. The method of claim 5 wherein translating user information comprises translating the user question.

8. The method of claim 1 initiating two-way communication comprises:
translating the second party response using an SMS aggregator;
transmitting the translated second party response to the first party.

9. A method of implementing a two-way communication module within a website comprising:
integrating a javascript library into website code;
adding a dialog container;
adding a HTML hyperlink; and
adding a JavaScript variable.
